(19) United States
(12) Patent Application Publication
(10) Pub. No.: US 2003/0164957 A1
(43) Pub. Date: Sep. 4, 2003

(54) Printing control apparatus and program that automatically select style sheet

(76) Inventor: Yoshio Komaki, Kobe-Shi (JP)

Correspondence Address: MORRISON & FOERSTER LLP, 1650 TYSONS BOULEVARD, SUITE 300, MCLEAN, VA, 22102, US

(21) Appl. No.: 10/360,626

(22) Filed: Feb. 10, 2003

(30) Foreign Application Priority Data
Feb. 15, 2002 (JP) 2002-038573

(51) Int. Cl. G06F 15/00; B41J 1/00

(52) U.S. Cl. 358/1.6

(57) ABSTRACT

An improved printing control apparatus capable of printing a text document such as an XML document using an appropriate style. The apparatus is provided with an obtaining part that obtains a text document to be printed and a selection part that selects a style sheet to be used for printing of the text document from among multiple style sheets that define a printing style in accordance with attribute information such as tag information regarding the text document.

This application is based on Japanese Patent Application No. 2002-38573 filed in Japan on Feb. 15, 2002, the entire content of which is hereby incorporated by reference.

### BACKGROUND OF THE INVENTION

1. Field of the Invention

The present invention relates to a printing control technology applicable during printing of text documents such as XML (eXtensible Markup Language) documents.

2. Description of Related Art

When printing a text document such as an XML document, such text document can be printed using a style sheet specified in that text document.

However, some XML documents do not clearly indicate the style sheet to be used use for printing. When printing such an XML document, printing is usually performed using the type of style sheet specified in advance. However, in many cases, the problem arises that the style sheet used for printing is not appropriate for the XML document.

This problem also occurs with regard to other types of text documents besides XML documents.

### OBJECT AND SUMMARY

An object of the present invention is to provide an improved printing control technology that resolves the problem identified above.

Another object of the present invention is to provide a printing control technology that enables the printing of various text documents using an appropriate style.

These objects are attained by providing a printing control apparatus comprising:

an obtaining part that obtains a text document to be printed; and

a selection part that, in accordance with attribute information regarding the text document, selects a style sheet to be used for the printing of the text document from among multiple style sheets that define a printing style.

In the apparatus described above, the attribute information may include at least one information category among the categories of tag information included in the text document, data type information included in the text document, and number of characters/letters information regarding the text document.

In the apparatus described above, the selection part may select the style sheet to be used for the printing of the text document by obtaining such style sheet over a network from an external apparatus connected to the network.

The apparatus described above may also include a changing part that changes the font size defined for the selected style sheet in accordance with the number of characters/letters in the text document.

In the apparatus described above, the text document may be an XML document.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a summary diagram showing the overall construction of a print system 1;

FIG. 2 is an illustration of the external view of an MFP 10;

FIG. 3 is a block diagram showing the construction of a part of the MFP 10;

FIG. 4 is a function block diagram showing the various functions of the MFP 10;

FIG. 5 is a flow chart showing the basic operations of the MFP 10;

FIG. 6 is a flow chart showing the details of one of the operations shown in the flow chart of FIG. 5;

FIG. 7 is a drawing showing the content of a management table TB;

FIG. 8 is a drawing showing a printing output example using a style sheet S11;

FIG. 9(a) is a drawing showing an output example using a style sheet S11;

FIG. 9(b) is a drawing showing an output example using a style sheet S12; and

FIG. 9(c) is a drawing showing an output example using a style sheet S13.

### DETAILED DESCRIPTION OF THE PREFERRED EMBODIMENTS

An embodiment of the present invention is described below with reference to the drawings.

<A. System Construction>

<A1. Overall Construction>

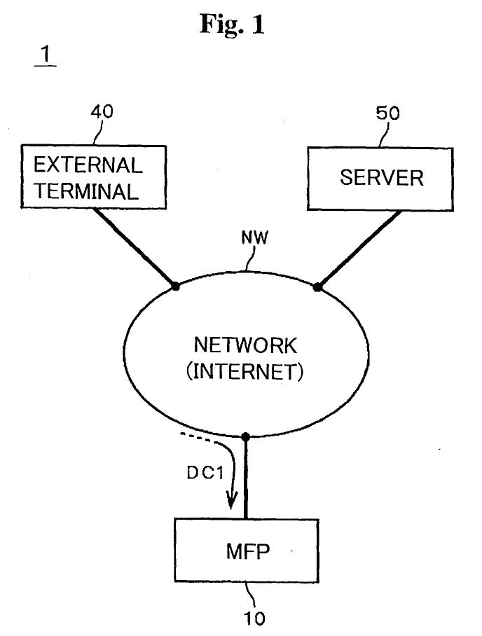

FIG. 1 is a summary diagram showing the overall construction of a print system 1 pertaining to an embodiment of the present invention. The print system 1 includes a multi-function peripheral (hereinafter ‘MFP’) 10, an external terminal 40, and a server 50.

The MFP 10, the external terminal 40 and the server 50 are connected to a network NW, and can send and receive to and from each other over this network NW data of various types, including text documents. The ‘network’ is a network of communication lines responsible for data communication, and specifically, comprises various communication networks consisting of electric communication lines (including optical communication lines), such as LANs, WANs and the Internet. The form of connection to the network may be continuous using dedicated lines, or temporary, such as that created by a dial-up connection using public telephone lines including analog lines or digital lines (ISDN). The data transmission method may be either wireless or wired.

The MFP 10 is a multi-function apparatus having the functions of a scanner, copying machine, printer, facsimile machine, etc., and can send and receive data over the network. As described below, the MFP 10 functions not only as a printing control apparatus pertaining to the embodiment of the present invention but also as a printing output apparatus. Consequently, as descried below, the MFP 10 can print a received text document based on an appropriate style sheet.

The external terminal 40 is a network terminal that can be connected to the network NW, and can communicate with the MFP 10 over the network. For example, a personal computer, a cellular phone, a digital camera or an MFP may function as this external terminal 40.

The server 50 is a WWW (World Wide Web) server connected to the network, and is capable of communication with the MFP 10 based on a protocol such as HTTP (HyperText Transfer Protocol). The MFP 10 can receive text documents such as XML documents from the server 50 using a protocol such as HTTP.

It is preferred that the server 50 also function as a mail server. In that case, the MFP 10 can receive e-mails from the external terminal 40 comprising an apparatus such as a cellular phone. An e-mail consists of a text document in XML, HTML or text format.

As described below, text documents received in this way are printed out by the MFP 10.

<A2. MFP>

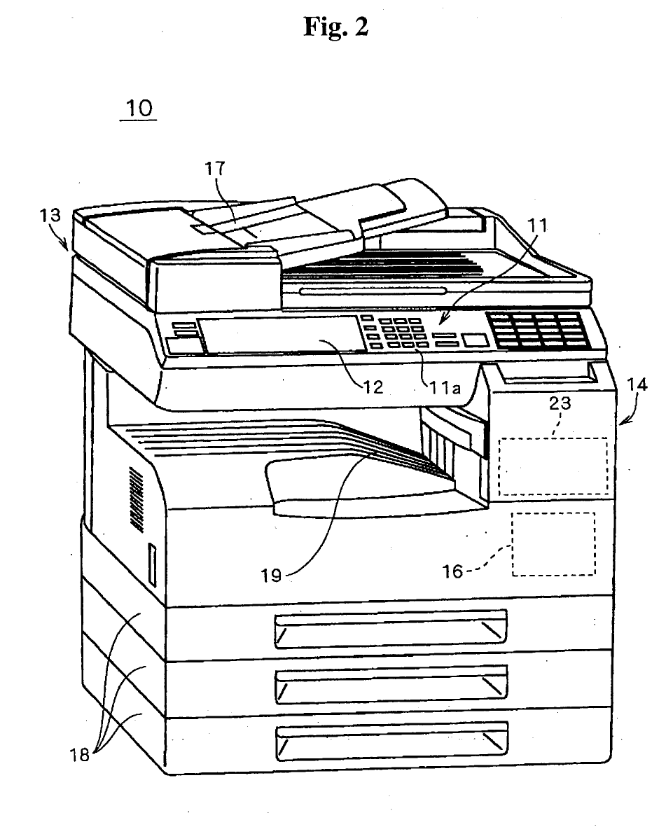

FIG. 2 is an illustration showing an external view of the MFP 10.

The MFP 10 includes multiple keys 11a, as shown in FIG. 2, as well as an operation unit 11 that receives various commands via user operation of these keys and input of data comprising characters/letters or numbers, a display 12 that displays information and the like regarding command menus for the user and obtained images, a scanner 13 that obtains image data via opto-electrical reading of the original document, and a printing unit 14 that prints images on recording sheets based on the image data.

The MFP 10 also includes a feeder 17 that sends the original document to the scanner 13 and is located on the top surface of the main unit, a paper supply unit 18 that supplies recording sheets to the printing unit 14 and is located in the lower part of the main unit, a tray 19 that is located in the center of the main unit and onto which recording sheets on which an image has been printed are ejected by the printing unit 14, a communication unit 16 that sends and receives image data and the like to and from external apparatuses over the network and is located inside the main unit, and a storage unit 23 that stores image data and the like. In addition, the MFP 10 has a network interface not shown in the figures, and the communication unit 16 is connected to the network via the network interface such that various types of data can be transmitted to and from external apparatuses.

The display 12 is used for the display of various kinds of information including a list of recipients for data transmission, and the operation unit 11 is used for various types of input including selection of recipients by the user. The display 12 comprises a liquid crystal panel that has a built-in contact sensor or similar device that enables it to detect the location of the display 12 touched by the finger or the like of the operator. Therefore, the operator can input various commands by pressing various virtual buttons or the like displayed on the display 12 using his or her finger or the like. The display 12 has the operation input function described above. These operation unit 11 and the display 12 function as important components of the user interface.

The scanner 13 obtains image data by opto-electrically reading image information such as photograph, character/letter or picture information from the original document. The image data (density data) obtained is converted into digital data by an image processor not shown, and after undergoing various types of public domain image processing, it is sent to the printing unit 14 or the communication unit 16 and used for image printing or data transmission, or is stored in the storage unit 23 for later use.

The printing unit 14 prints images on recording sheets based on image data obtained by the scanner 13, image data received from an external apparatus by the communication unit 16 or image data stored in the storage unit 23. The printing unit 14 can print not only image data but also text documents (such as e-mails) received from external apparatuses and the like. The printing unit 14 is a printing output unit that performs various types of printing as described above.

The communication unit 16 sends and receives facsimile data over public telephone lines, as well as data over the network to and from external apparatuses connected to a network such as a LAN or the Internet via e-mail or the like. As a result, the MFP 10 functions not only as a facsimile machine that performs normal facsimile communication but also as an e-mail transmission/reception terminal.

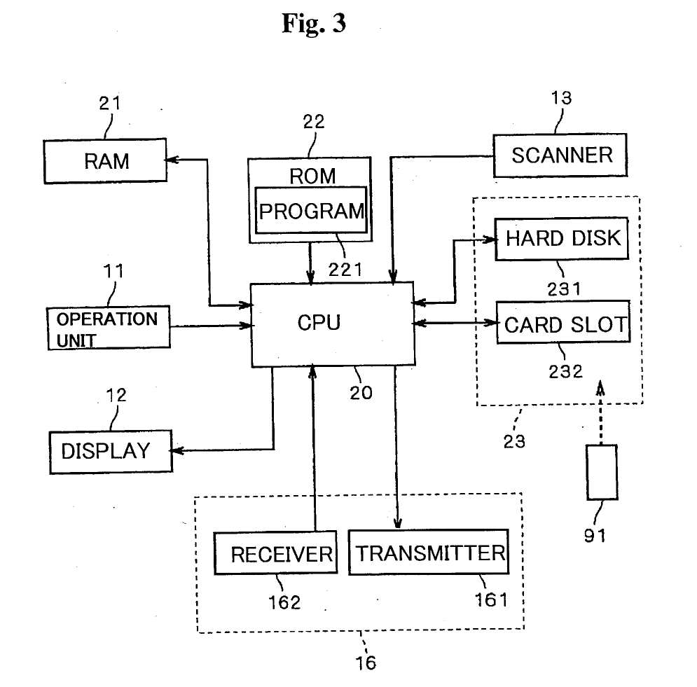

FIG. 3 is a block diagram that mainly shows, of the components of the MFP 10, the components pertaining to this embodiment. The MFP 10 includes a CPU 20 that performs various calculations and controls the overall operations of the MFP 10, and a RAM 21 that stores various types of data and a ROM 22 that stores a prescribed software program (hereinafter referred to simply as ‘program’) 221 are connected to the CPU 20. The operation unit 11, the display 12, the scanner 13 and the storage unit 23 are also connected to the CPU 20. The storage unit 23 comprises a hard disk 231 that stores image data and the like and a card slot 232 that reads information from the memory card 91. The RAM 21 is a non-volatile RAM.

Via the construction described above, various types of data can be transferred between the RAM 21, the scanner 13, the hard disk 231 and the memory card 91 inserted in the card slot 232 under the control of the CPU 20, and the information stored in the RAM 21, the hard disk 231 or the memory card 91 is displayed on the display 12 under the control of the CPU 20.

Furthermore, the communication unit 16, which includes a transmitter 161 and a receiver 162 by which to send and receive data to and from external apparatuses connected over the network, is also connected to the CPU 20.

As described above, the MFP 10 comprises a computer system (hereinafter referred to as simply a ‘computer’) that includes the CPU 20 and other components. By incorporating the prescribed program executed by this computer, the MFP 10 functions as a printing control apparatus having the various functions described below.

The program 221 is stored in the ROM 22 in this embodiment, but it may be stored in the RAM 21. The program stored in the RAM 21 may be obtained via reading of a program stored in the memory card 91, which operates as a recording medium. Alternatively, such a program may be incorporated into the MFP 10 from an external apparatus via communication over the network instead of being directly read from a recording medium such as the memory card 91.

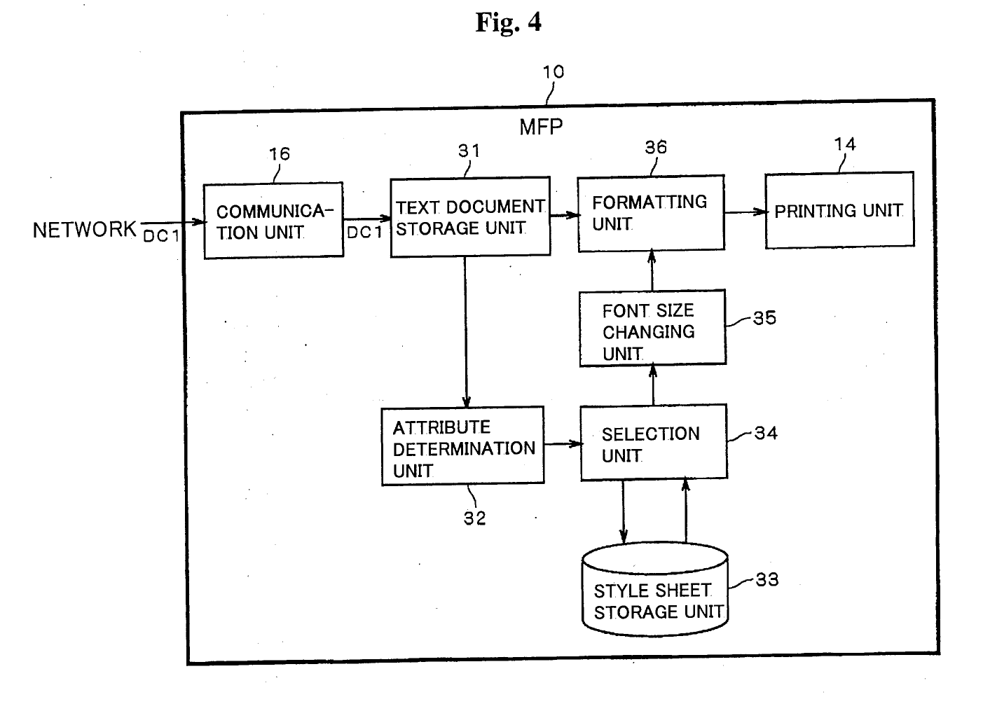

FIG. 4 is a function block diagram showing the various functions of the MFP 10. As shown in FIG. 4, the MFP 10 includes, in addition to the printing unit 14 and the communication unit 16 described above, a text document storage unit 31, an attribute determination unit 32, a style sheet storage unit 33, a selection unit 34, a font size changing unit 35 and a formatting unit 36. These components are functionally realized via the hardware resources such as the CPU 20, the RAM 21, the ROM 22 and the storage unit 23 described above. The operations of these components are described below.

<B. Operations>

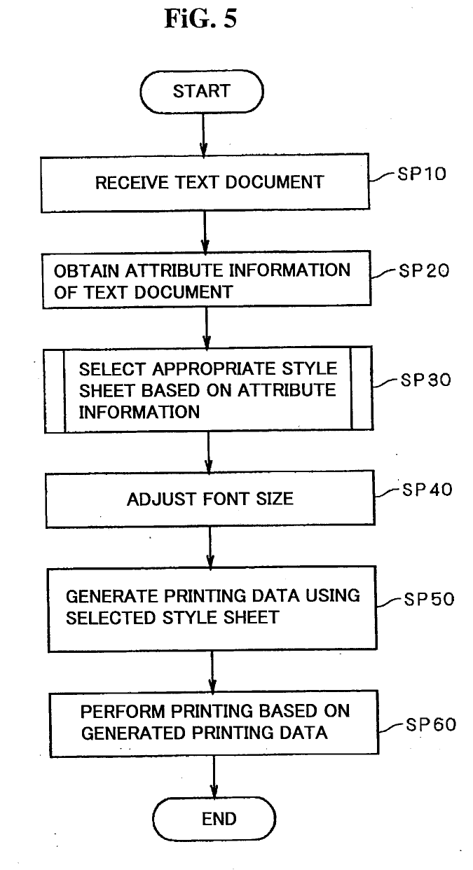

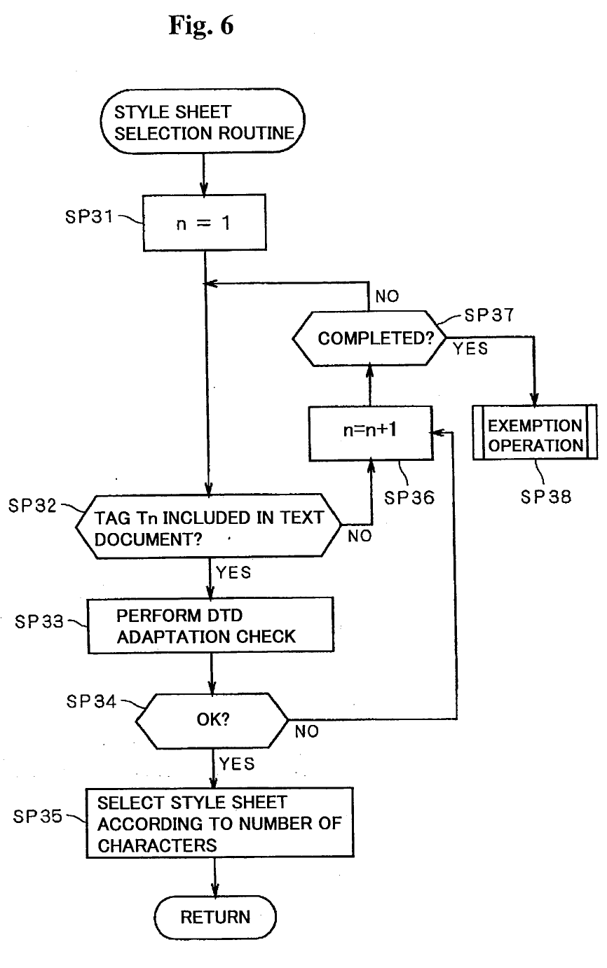

The printing control and the printing output operations performed by the MFP 10 are explained below with reference to the function block diagram of FIG. 4 and the flow charts of FIGS. 5 and 6. FIG. 5 is a flow chart showing the overall routine of these operations and FIG. 6 is a flow chart showing a part of such routine.

First, in step SP10 (FIG. 5), the text document to be printed is obtained. Specifically, the communication unit 16 of the MFP 10 (FIG. 4) receives an XML document DC1 from an external apparatus over the network NW. For example, this XML document DC1 is received as an e-mail. The received XML document DC1 is stored in the text document storage unit 31.

A situation in which the XML document DC1 is received from an external apparatus over the network NW is shown as an example here, but the present invention is not limited to this situation. For example, it is also acceptable if the operator of the MFP 10 specifies, using the operation unit 11 and/or the display 12, as the document to print a prescribed text document or the like stored in the storage unit 23 or the like within the MFP 10.

In step SP20, the attribute determination unit 32 determines the attribute information regarding the XML document DC1 received and obtains it. In this example, the attribute determination unit 32 obtains three types of information as the ‘attribute information’ regarding the XML document DC1, i.e., ‘tag information’ included in the XML document DC1, ‘DTD (Document Type Definition) information’ included in the XML document DC1, and ‘number of characters/letters information’ regarding the XML document DC1.

The XML document DC1 tag information is text-based information embedded in the document as a tag by which to identify the type of the document. This tag information is obtained by the attribute determination unit 32 via recognition and extraction. For example, a tag ‘<trip report>’ that indicates that the document comprises a ‘trip report’, a tag ‘<technical memorandum>’ that indicates that the document comprises a ‘technical memorandum’, or other tag is extracted.

The XML document DC1 DTD information is information by which to identify the document type of the XML document DC1. This DTD information may also be referred to as ‘data type information’. This DTD is extrapolated from the above tag information as described below in this example.

The XML document DC1 number of characters/letters information is information that indicates the number of characters/letters contained in the XML document DC1. The attribute determination unit 32 obtains this number of characters/letters information by counting the number of characters/letters in the XML document DC1. It is preferred that of all characters/letters contained in the XML document DC1, the ‘number of effective characters/letters’, which is the number of characters/letters contained in the actual text, be obtained as this number of characters/letters information.

In the next step SP30, a style sheet appropriate for the XML document DC1 is selected based on the attribute information thereof. This selection is performed by the selection unit 34. The style sheet storage unit 33 stores multiple style sheets that define the printing style (i.e., the output format for printing), and the selection unit 34 selects, in accordance with the attribute information of the XML document DC1, a style sheet to be used for the printing of the XML document DC1 from among the multiple style sheets stored in the style sheet storage unit 33. Descriptions based on XSL (XML Style Language) may be used as style sheets.

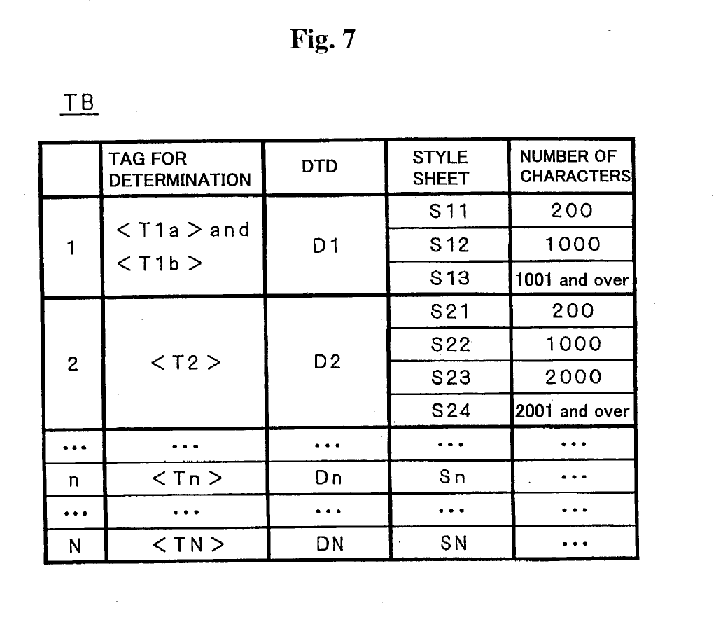

Specifically, the selection unit 34 selects, based on the attribute information obtained by the attribute determination unit 32 and a management table TB shown in FIG. 7, a style sheet to be used. The management table TB represents information (data) that associates the XML document DC1 attribute information with a style sheet for printing, and is stored in the style sheet storage unit 33.

In this example, a situation is described in which the data type of the XML document DC1 is extrapolated based on the identification tag contained in the document, and it is verified that the XML document DC1 matches the extrapolated data type using the DTD information. In addition, in this example, a situation is described in which multiple style sheets are associated with one data type, and one of these style sheets is associated with the XML document DC1 based on the number of characters/letters information regarding the XML document DC1.

For example, where an identification tag T1a and an identification tag T1b are both included in the XML document DC1, it is extrapolated that the document has the data type D1 (see FIG. 7). Using the DTD that defines the data type D1, it is determined whether or not the XML document DC1 has the data type D1.

Where it is confirmed that the XML document DC1 has the data type D1, a style sheet is selected as most appropriate for the XML document DC1 from among the style sheets S11, S12 and S13, based on the number of characters/letters information regarding the XML document DC1. More specifically, where the number of characters/letters in the XML document DC1 is 200 or less, the style sheet S11 is associated with the document, and where the number of characters/letters is between 201 and 1,000, the style sheet S12 is associated with the document. Where the number of characters/letters in the XML document DC1 is 1,001 or more, the style sheet S13 is associated with the document.

Where it is determined that the XML document DC1 is not of the data type D1, operations to determine the type of the XML document DC1 continue. Specifically, operations to determine whether or not the XML document DC1 has the data type D2 are carried out.

Where an identification tag T2 is included in the XML document DC1, it is estimated that the XML document DC1 has the data type D2. Where it is confirmed that the XML document DC1 has the data type D2 using the DTD, a style sheet is selected as most appropriate for the XML document DC1 from among the style sheets S21, S22, S23 and S24 based on the number of characters/letters information regarding the XML document DC1. More specifically, where the number of characters/letters in the XML document DC1 is 200 or less, the style sheet S21 is associated with the document, and where the number of characters/letters is between 201 and 1,000, the style sheet S22 is associated with the document. Where the number of characters/letters in the XML document DC1 is between 1,001 and 2,000, the style sheet S23 is associated with the document, and where the number of characters/letters is 2,001 or more, the style sheet S24 is associated with the document.

The same operations apply to other tags Tn, and a style sheet appropriate for the XML document DC1 is selected.

The details of the routine to select a style sheet will now be explained with reference to FIG. 6.

First, in step SP31, the tag number is initialized (n=1). It is then determined whether or not a tag Tn (specifically, because n=1 in this example, it is T1 or tags T1a and T1b) is included in the XML document DC1 to be printed. In order to extrapolate the type of the document with increased accuracy, it is determined in this example whether or not two tags, i.e., the tags T1a and T1b, are included.

Where it is determined that both of the tags T1a and T1b are included, the CPU 20 moves to step SP33, and verifies that the document matches the data type using the DTD. Where the result of the verification is positive, it is determined that the XML document DC1 has the data type D1, for example, and the CPU 20 moves to the next step SP35.

Where it is determined, on the other hand, that at least one of the tags T1a and T1b is not included in step SP32, or where the result of the verification in step SP34 is negative, indicating that the XML document DC1 does not match the data type D1, the CPU 20 increases the tag number in step SP36, and after a routine end determination (step SP37), the CPU 20 returns to step SP32. In the routine end determination operation in step SP37, it is determined whether or not the tag number (n) to be checked has reached the end number (i.e., the largest number N). Specifically, where the tag number (n) after the increase is larger than the end number (i.e., n>N), it is determined that an appropriate style sheet could not be selected, and the CPU 20 ends the checking operation and moves to the exemption operation (step SP38). As described below, it is also acceptable if before moving to the exemption operation, the CPU 20 checks for a style sheet appropriate for the XML document DC1 using information from other database connected to the network.

Where the tag number (n) has been increased to n=2 and the CPU 20 has moved to step SP32, it is determined whether or not the tag T2 is included the XML document DC1 to be printed.

Where it is determined that the tag T2 is included, the CPU 20 moves to step SP33 and verifies that the document matches the data type using the DTD. Where the result of the verification is positive, it is determined that the XML document DC1 has the data type D2, and the CPU 20 moves to the next step SP35.

Where it is determined, on the other hand, that the tag T2 is not included in step SP32, or where the result of the verification in step SP34 is negative, indicating that the XML document DC1 does not match the data type D2, the CPU 20 increases the tag number in step SP36, and after conducting a routine end determination (step SP37), the CPU 20 returns to step SP32.

By repeating these operations, the style sheet appropriate for the XML document DC1 is determined.

Where it is determined through the above operations that the XML document DC1 has the data type D1, for example, as shown in the management table TB of FIG. 7, the XML document DC1 is associated with one of the three style sheets S11, S12 and S13. In other words, because the document type of the XML document DC1 can be identified via the above operations, a style sheet appropriate for the XML document DC1 can be associated with the document. More specifically, one of the style sheets S11, S12 and S13 can be associated with the XML document DC1 comprising a <trip report> in accordance with the document type thereof. The style sheets S1, S12 and S13 have the common feature that they all define a style that is appropriate for printing a <trip report> document, and differ from each other in that they define a more appropriate style depending on the number of characters/letters, as described above.

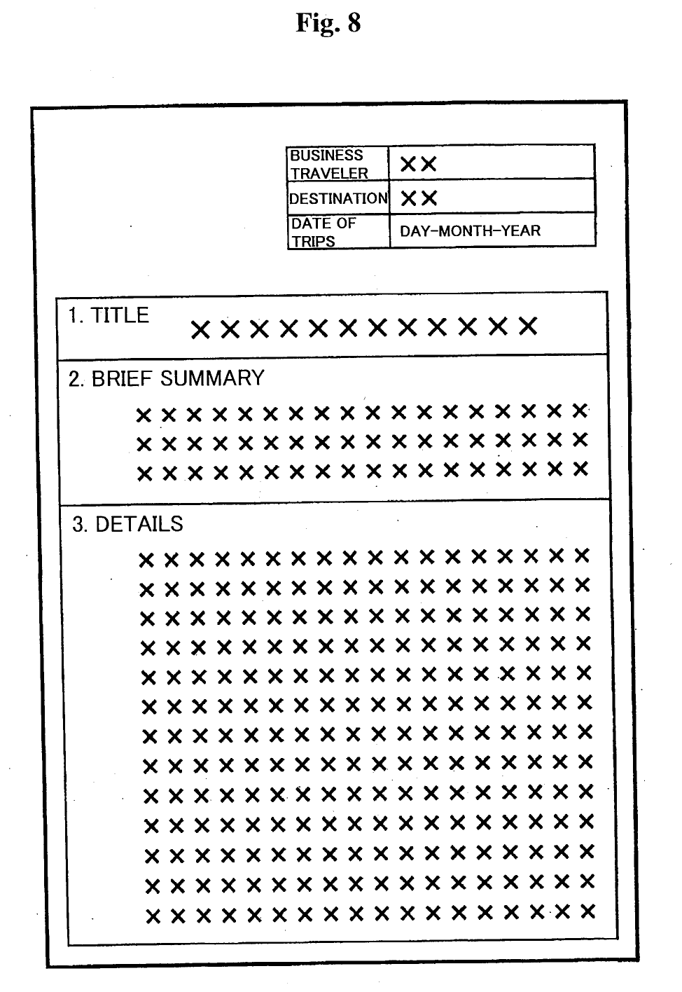

FIG. 8 shows a printing output example using the style sheet S11. In FIG. 8, the text of each description item included in the XML document DC1 comprising a ‘trip report’ is output using an organized layout.

Where the XML document DC1 has the document type that indicates <trip report>, the appropriate style sheet S11 or the like shown in FIG. 8 can be selected via the above operations. If printing is performed using this style sheet, the XML document DC1 can be obtained in the printed form using the style sheet S11 (or S12 or S13) appropriate for trip report printing. In other words, the XML document DC1 is not associated with any other style sheets that are inappropriate for the XML document DC1 (such as the style sheets S21, S22, S23 or S24 that are appropriate for technical memorandum printing). The MFP 10 can print the XML document DC1 in this way using the appropriate style in accordance with the type (content) of the document.

When the result of the determination regarding the data type of the XML document DC1 is obtained, the CPU 20 proceeds to step SP35.

As described above, the three style sheets S11, S12 and S13 are associated with the XML document DC1 that has the data type D1. In this step SP35, the appropriate style sheet is associated with the document from among the three style sheets S11, S12 and S13 in accordance with the number of characters/letters in the document.

Where the number of characters/letters in the XML document DC 1 is 500, for example, because the number of characters/letters in the document meets the condition that it falls between 201 and 1,000, the style sheet S12 is associated with the XML document DC1.

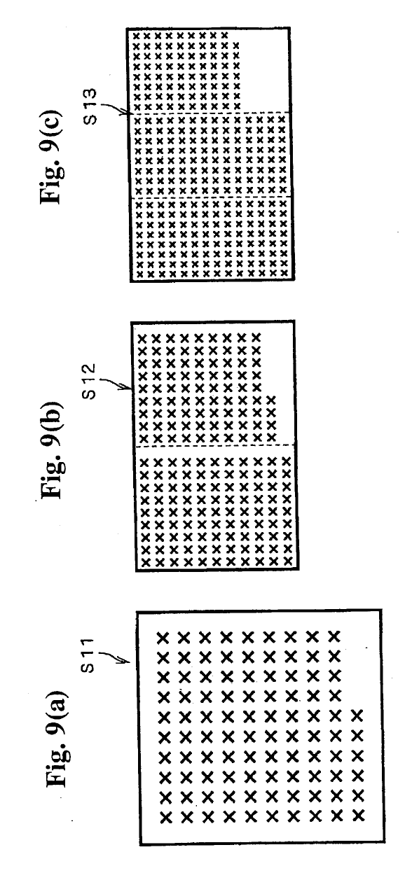

FIGS. 9(a) through 9(c) are drawings showing output examples using the three style sheets S11, S12 and S13. FIG. 9(a) represents an output example using the style sheet S11, FIG. 9(b) represents an output example using the style sheet S12, and FIG. 9(c) represents an output example using the style sheet S13. In FIGS. 9(a) through 9(c), in order to simplify the drawing, lines and layout of the characters/letters are omitted, and the differences among the style sheets are expressed using the font size and the density of the characters/letters

FIG. 9(a) represents a printing output example in which portrait orientation and a relatively large font are used for printing a <trip report> document having a relatively small number of characters/letters.

FIG. 9(b) represents a printing output example in which landscape orientation is used, the sheet is divided into two sections and a relatively small font is used for printing a <trip report> document having an average number of characters/letters.

FIG. 9(c) represents a printing output example in which landscape orientation is used, the sheet is divided into three sections and a smaller font is used for printing a <trip report> document having a relatively large number of characters/letters.

Because the appropriate style sheet can be selected in accordance with the number of characters/letters in the XML document DC1 in this way, the XML document DC1 can be printed using the appropriate style.

In the next step SP40, fine adjustment is performed regarding the font size. This operation is performed by the font size changing unit 35.

Specifically, the font size defined for the style sheet selected in the above step SP30 (i.e., S12 for example) is further changed depending on the number of characters/letters in the XML document DC1. One style sheet was selected from among the multiple style sheets having different numbers of sections depending on the number of characters/letters in the XML document DC1 in the above step SP30, but here, the situation is described in which the font size defined for the selected style sheet is further subjected to fine adjustment in accordance with the number of characters/letters.

For example, the number of characters/letters in the XML document DC1 that matches the style sheet S12 is between 201 and 1,000, representing a prescribed range. Therefore, while it is acceptable to define a font size based on a maximum of 1,000 characters/letters such that the area that corresponds to the number of characters/letters smaller than the maximum number is left blank, in this example, the font size is made as large as possible in order to improve the ease of reading.

Specifically, the closer the number of characters/letters in the XML document DC1 to the maximum number of characters/letters of the corresponding style sheet (1,000 in this case), the smaller the font size selected. Conversely, the closer the number of characters/letters in the XML document DC1 to the minimum number of characters/letters of the corresponding style sheet (201 in this case), the larger the font size selected.

Where the number of characters/letters in the XML document DC1 is 500, for example, the font size is made larger than when the number of characters/letters in the XML document DC1 is 1,000. Because the font size is changed in accordance with the number of characters/letters in the XML document DC1 in this way, a printing output that is easier to read can be obtained.

Thereafter, in step SP50, printing data based on which to print the XML document DC1 is prepared using the style sheet.

More specifically, the formatting unit 36 applies to the XML document DC1 the style sheet that was selected in step SP30 and subjected to fine adjustment in step SP40, and generates styled document data. Furthermore, the formatting unit 36 converts the styled document data into printing data. For the printing data, data described using a page description language such as PCL (Printer Control Language) or PS (PostScript®) can be adopted, for example.

In step SP60, the printing unit 14 performs printing based on the generated printing data. In other words, the printing unit 14 prints out the XML document DC1 onto the sheet.

Because the MFP 10 can select style sheets appropriate to various text documents as described above, printed products printed using various appropriate styles can be obtained.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

In the embodiment described above, verification was carried out using the DTD obtained indirectly through extrapolation using the tag information, but the present invention is not limited to this implementation. For example, it is also acceptable if the DTD described in the XML document DC1 is directly obtained and verification is carried out using this DTD. Specifically, it is acceptable if the DTD information described (or specified) in the XML document DC1 is directly extracted by the attribute determination unit 32 and the extracted DTD is used. By carrying out verification using the DTD obtained directly or indirectly in this fashion, the content of the XML document DC1 can be more appropriately determined.

Alternatively, instead of performing verification using the DTD, the style sheet for the XML document DC1 may be determined based on the tag information. Specifically, the operations of steps SP33 and SP34 may be omitted. In this case, the operations to determine the content of the XML document DC1 are simplified.

In the embodiment described above, a situation in which a style sheet to be applied to the XML document DC1 is selected from among multiple style sheets stored in the MFP 10 was described as an example, but the present invention is not limited to this implementation. For example, it is also acceptable if a style sheet stored in an external apparatus connected to the network NW is obtained from outside the MFP 10 over the network NW as the style sheet for the XML document DC1. More specifically, a style sheet stored on the server 50 or the like may be obtained over the network NW. Consequently, a more appropriate style sheet can be selected for various types of XML documents DC1.

In the embodiment described above, a situation in which data (i.e., the management table TB) that defines the association between the XML document attribute information and a printing style sheet is located in the MFP 10 was described as an example, the present invention is not limited to this implementation. Data (i.e., a management table) that incorporates such definitions may be stored in another apparatus such as the server 50, such that the data can be obtained from the server.

In the embodiment described above, a situation in which an appropriate style sheet is automatically selected from among multiple applicable style sheets in step SP35 based on the number of characters/letters was described, but the present invention is not limited to this implementation. For example, it is also acceptable if the operator manually specifies in step SP35 an appropriate style sheet from among the three applicable style sheets S11, S12 and S13. Some of the operations described above may be carried out based on commands from the operator in this way.

In the embodiment described above, an MFP that has a function to perform printing output was used as an example of a printing control apparatus, but the present invention is not limited to this implementation. It can be applied to any apparatus that is capable of performing printing control regarding text documents (i.e., XML documents, etc.).

For example, the printing control apparatus of this invention may be realized as a printer that has a function to control printing and a function to perform printing output but does not have the functions of a scanner, copying machine or facsimile.

Alternatively, the function to perform printing output may be included separately in a different printing output apparatus, and the printing control apparatus of the present invention may constitute a printing control apparatus that performs control of that printing output apparatus. More specifically, the printing control apparatus having the above functions may be realized by a computer such as a personal computer that executes a prescribed program. The technological concept described above can be applied not only in an apparatus but also in a program by which to realize the above functions. Such a program can be provided as data recorded on various types of recording media, such as a memory card or a CD-ROM. The printing control apparatus (comprising an MFP or a personal computer, for example) can perform the various functions described above by reading the program recorded on the recording medium and executing the program using its built-in CPU and the like. Furthermore, the printing control apparatus may incorporate the program by downloading it over the network from a prescribed server or the like.

In the above embodiment, an XML document DC 1 was used as an example of the text document, but the present invention is not limited to this implementation, and other types of text documents may be used. For example, the present invention can be applied to documents written in HTML (hereinafter referred to as ‘HTML documents’), and the document type may be determined based on a keyword included in the HTML document, with the style sheet for the HTML document determined based on the document type determination result. Similarly, the style sheet for the HTML document may be determined based on the number of characters/letters information obtained from counting of the number of characters/letters in the HTML document.

What is claimed is:

1. A printing control apparatus comprising:
an obtaining part for obtaining a text document to be printed; and
a selection part for, in accordance with attribute information regarding the text document, selecting a style sheet to be used for printing of the text document from among multiple style sheets that define a printing style.

2. A printing control apparatus according to claim 1, wherein the attribute information includes at least one information category among categories of tag information included in the text document, data type information included in the text document, and number of characters/letters information regarding the text document.

3. A printing control apparatus according to claim 1, wherein the selection part selects the style sheet to be used for the printing of the text document by obtaining the style sheet over a network from an external apparatus connected to the network.

4. A printing control apparatus according to claim 1, further comprising a changing part for changing a font size defined for the selected style sheet in accordance with the number of characters/letters in the text document.

5. A printing control apparatus according to claim 1, wherein the text document is an XML document.

6. A computer program product executable by a computer for controlling printing operation, the computer program product including the following instructions of:
obtaining a text document to be printed; and
selecting a style sheet to be used for printing of the text document from among multiple style sheets that define a printing style in accordance with attribute information regarding the text document.

7. A computer program product according to claim 6, wherein the attribute information includes at least one information category among categories of tag information included in the text document, data type information included in the text document, and number of characters/letters information regarding the text document.

8. A computer program product according to claim 6, further including a instruction of changing a font size defined for the selected style sheet in accordance with the number of characters/letters in the text document.

9. A computer program product according to claim 6, wherein the text document is an XML document.

10. A method for controlling printing operation, comprising the following steps of:
obtaining a text document to be printed; and
selecting a style sheet to be used for printing of the text document from among multiple style sheets that define a printing style in accordance with attribute information regarding the text document.

11. A method according to claim 10, wherein the attribute information includes at least one information category among categories of tag information included in the text document, data type information included in the text document, and number of characters/letters information regarding the text document.

12. A method according to claim 10, further including a method of changing a font size defined for the selected style sheet in accordance with the number of characters/letters in the text document.

13. A method according to claim 10, wherein the text document is an XML document.
